(19) United States
(12) Patent Application Publication
(10) Pub. No.: US 2006/0147618 A1
(43) Pub. Date: Jul. 6, 2006

(54) Slit coater with a service unit for a nozzle and a coating method using the same

(75) Inventors: O Jun Kwon, Gyeongnam (KR); Kang Il Cho, Yongin (KR); Ji Seong Noh, Suwon (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/211,211

(22) Filed: Aug. 19, 2005

(30) Foreign Application Priority Data
Dec. 31, 2004 (KR) 118358/2004
Dec. 31, 2004 (KR) 118443/2004
Aug. 17, 2005 (KR) 75304/2005

(51) Int. Cl. B05D 5/12; B05D 5/06; B05D 3/12; B05B 15/02; G02F 1/133

(52) U.S. Cl. 427/162; 427/356; 427/58; 118/302

(57) ABSTRACT

A slit coater including a service unit and a coating method using the same prevents hardening of a coating solution at an outlet of the slit nozzle and maintains constant discharge conditions for the application of a uniform coating solution. The slit nozzle is kept in the service unit, which has a solvent atmosphere with cleaning solution spray nozzles and cleaning solution in an internal lower portion thereof. The slit nozzle periodically discharges dummy coating solution. The slit coater having the service unit includes a table on which an object to be processed is positioned, a slit nozzle unit for applying coating solution onto a surface of the object, and a service unit onto which the slit nozzle unit is loaded when the unit is in service, and having an inner space maintained in a substantially sealed solvent atmosphere.

### PRIORITY CLAIM

This application claims priority to Korean patent application No. 118443/2004 and to application No. 118358/2004 both filed Dec. 31, 2004 and to application No. 75304/2005 filed Aug. 17, 2005, the disclosures of which are incorporated by reference herein.

### TECHNICAL FIELD

The present invention relates, generally, to a slit coater and a method for fabricating an LCD device using the slit coater and, more particularly, to a slit coater having a service unit for preventing hardening of a coating solution in an outlet of the slit nozzle or for pre-applying coating solution to improve the performance of the slit coater. In one function, the service unit prevents hardening of the coating solution when the slit nozzle has not performed an applying operation for a certain period of time, but is on standby and a coating method using the same. In another function, the service unit pre-applies coating solution to a roller so that highly-concentrated coating solution within the slit nozzle is discharged and discarded before or after the application process.

### BACKGROUND

When a flat panel display device or a semiconductor device is fabricated, a process for depositing a thin film, a photolithography process for exposing a region selected in the thin film, and an etching process for removing the thin film of the selected region are performed several times. Particularly, the photolithography process includes a coating process for forming a photosensitive film of a photosensitive solution such as photoresist on a substrate or a wafer, and an exposing and developing process for patterning the photosensitive film by using a mask with a predetermined pattern.

In general, a spray coating method, a roll coating method, a spin coating method, or the like is used in the coating process for forming a photosensitive film on a substrate and a wafer.

Because the spray coating method and the roll coating method are not suitable to achieve high precision in the uniformity of a coating film and the adjustment of a thickness of the film, the spin coating method is used for high-precision pattern formation.

A spin coater used in the spin coating method will now be described in detail with reference to accompanying drawings.

FIG. 1 is a sectional view which illustrates the structure of a general spin coater.

As shown, the spin coater includes a spin chuck 5 that is connected to a rotating shaft 6. A cover 7 that surrounds the spin chuck 5 and can be opened and closed. A nozzle 4 is placed above the spin chuck 5 and moves into the cover 7 when the cover 7 is opened.

An object 10 to be processed and coated with a photosensitive film is mounted on the spin chuck 5, and a drain valve (not shown) for discharging photosensitive solution, such as photoresist, to the outside is installed at a lower portion of the cover 7.

In order to form a coating film on the predetermined object 10, first, the nozzle 4 of the spin coater having the aforementioned structure is lowered and sprays photosensitive solution onto a surface of the object 10, which has been placed on the spin chuck 5.

When the photosensitive solution is sprayed onto the object 10, the cover 7 is hermetically closed, a motor (M) is rotated, and the rotating shaft 6 connected thereto is rotated, thereby rotating the spin chuck 5 with the object 10 a certain number of times.

When the spin chuck 5 is rotated, the photosensitive solution on the surface of the object 10 is spread out by a centrifugal force, thereby applying the photosensitive solution over an entire surface of the object 10.

After the photosensitive solution is applied over the entire surface of the object 10, the applied photosensitive solution is hardened. Then, a predetermined pattern is formed on the surface of the object 10 through exposure and development using a photo mask or the like.

Although the spin coating method using the spin coater is suitable to coat a small object, such as a wafer with a photosensitive film, it is not suitable to coat a large and heavy substrate, such as a flat panel display device having a glass substrate for a liquid crystal display panel with a photosensitive film.

This is because it gets harder to rotate a substrate at a high speed as the substrate gets larger and heavier. Further, damage to the substrate can occur and a lot of energy is consumed when the substrate is rotated at a high speed.

Also, the spin coating method is disadvantageous in that a large amount of photosensitive solution is wasted in comparison with the amount of photosensitive solution used in the photolithography process. In particular, a considerable amount of photosensitive solution is dispersed outside the spin chuck at the time of high-speed rotation, and is wasted. Substantially, the amount of wasted solution is much larger than the amount of solution used for the coating, and the dispersed photosensitive solution form particles that contaminate following thin film forming processes. The particles can also cause environmental pollution.

### BRIEF SUMMARY

In accordance with the present invention, there is provided a slit coater having a service unit for a nozzle configured to uniformly apply coating solution such as photosensitive solution, development solution, or a color filter on a large-area substrate and a coating method using the same. The slit coater having a service unit for a nozzle is configured to prevent hardening of coating solution at an outlet of the slit nozzle, and therefore maintaining the same discharge conditions and a coating method using the same.

In accordance with another aspect of the present invention, there is provided a slit coater having a service unit for a nozzle, including a table on which an object to be processed is positioned; a slit nozzle unit for applying coating solution onto a surface of the object to be processed; and a service unit for a nozzle onto which the slit nozzle unit is loaded and is on service, and having an inner space maintained in a hermetically sealed solvent atmosphere.

In accordance with another aspect of the present invention, there is provided a method for coating an application film, including coating an object to be processed with a coating solution by using a slit nozzle from a slit coater; loading the slit nozzle onto a service unit for the nozzle in which a solvent atmosphere is maintained with the cleaning solution by having the slit nozzle on service; discharging dummy coating solution to the service unit from the slit nozzle; separating the slit nozzle from the service unit of the nozzle; and coating the object to be processed with the coating solution.

In accordance with yet another aspect of the present invention, there is provided a coating system including a slit nozzle unit configured to apply a coating solution onto a surface of an object, and a service unit configured to receive at least a nozzle of the slit nozzle unit, wherein the coating solution does not harden in the nozzle while in the service unit.

In accordance with still another aspect of the invention, a method for fabricating an LCD device includes moving a slit nozzle to a service unit and pre-applying coating solution in the service unit, wherein the service unit has an inner space maintained in a substantially sealed solvent atmosphere. An LCD substrate is coated with a coating solution by moving the slit nozzle to an LCD substrate and coating the LCD substrate with the coating solution using the slit nozzle.

The foregoing and other features, aspects, and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view illustrating a structure of a related art spin coater;

FIGS. 2A and 2B are perspective views illustrating a slit coater and application of photosensitive solution by the slit coater in accordance with an embodiment of the invention;

FIG. 3 is a front view schematically illustrating a slit coater having a service unit for a nozzle in accordance with the present invention;

FIG. 4 is a cross-sectional view schematically illustrating a service unit of a coater in accordance with an embodiment of the present invention;

FIG. 5 is a cross-sectional view schematically illustrating a structure of a slit nozzle;

FIG. 6 is a cross-sectional view schematically illustrating a service unit of a nozzle in accordance with another embodiment of the present invention;

FIG. 7 is a cross-sectional view of a service unit in accordance with yet another embodiment of the present invention.

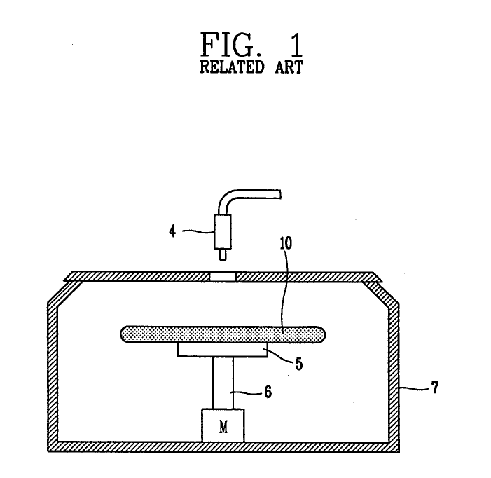

### DETAILED DESCRIPTION

Reference will now be made in detail to the preferred embodiments of a slit coater having a service unit for a nozzle and a method of coating using the service unit, examples of which are illustrated in the accompanying drawings.

In general, as mentioned above, a photolithography process is required in the field of semiconductor manufacture and the field of flat panel display device in order to pattern a thin film performing a specific function, for example, an insulation film, a metal thin film, a semiconductor thin film or the like, into a desired form. Here, photosensitive solution such as photoresist, which chemically reacts to light, is used in the photolithography process.

A photosensitive film having a uniform thickness should be formed on a substrate on which a thin film has been formed, so that a defect does not occur during the process. For example, if the photosensitive film has a thickness greater than a designated thickness, a portion of the thin film which should be etched is not etched, and if the photosensitive film has a thickness smaller than the designated thickness, the thin film is excessively etched. Also, the uniform application of the photosensitive solution is one of the most important issues as the substrate becomes larger due to an increase in size of the liquid crystal display panel of a liquid crystal display (LCD) device.

In accordance with an embodiment of the invention, a nozzle method in which a certain amount of photosensitive solution is applied by using a slit nozzle is employed in place of a related art spinner. A coating apparatus employing such a nozzle method is referred to as a spinless coater because a spinner is not used. Alternatively, the term “slit coater” is used because photosensitive solution is applied through a slit. The slit coater supplies the photosensitive solution through a nozzle having a slit shape with a length longer than its width, and applies the photosensitive solution onto a surface of a substrate in a plane form, which makes the slit coater suitable to apply the photosensitive solution to a large LCD device.

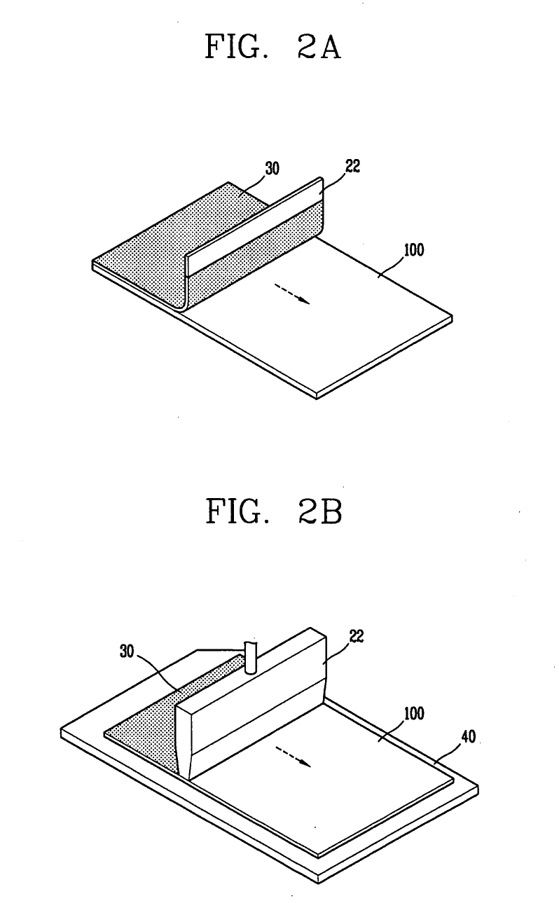

FIGS. 2A and 2B are exemplary views illustrating a slit coater and the application of a photosensitive solution by the slit coater. In accordance with an embodiment of the invention, the slit coater is provided with a slit nozzle 22 having a narrow and long slit. Photosensitive solution 30 is supplied through the slit nozzle 22, thereby applying the photosensitive solution 30 on a surface of a substrate 100 in a plane form.

The slit coater is an apparatus that applies a certain amount of photosensitive solution 30 onto the substrate 100 or the like through a bar-shaped long slit nozzle 22. The slit coater applies a uniform amount of photosensitive solution 30 through a fine slit nozzle 22, moving from one side of the substrate 100 toward its other side at a constant speed, thereby forming a uniform photosensitive film on the surface of the substrate 100.

Also, because the slit coater can apply the photosensitive solution 30 only to a desired surface of the substrate 100, the coating solution can be used without being wasted as compared to the aforementioned spin coater. In addition, because the slit coater can apply the coating solution in a plane form with a long width, it is suitable for a large substrate or a quadrangular substrate.

For reference, element 40 indicates a table on which the substrate 100 is mounted, and the arrow indicates a direction in which the photosensitive solution is applied along a direction that the slit nozzle 22 moves.

The slit coater in accordance with the present invention may maintain the slit nozzle in the optimum state by keeping the slit nozzle in a service unit in which a solvent atmosphere is formed. The service unit is configured to maintain the optimum state during the times when a coating process is not performed and the slit coater is waiting for further use.

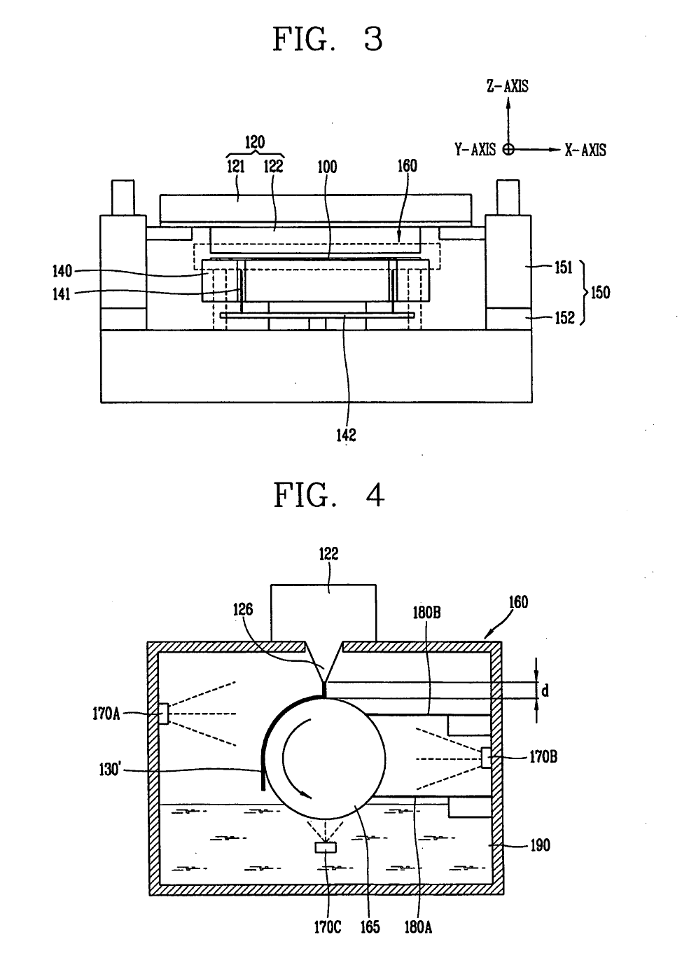

FIG. 3 is a front view schematically illustrating a slit coater having a service unit in accordance with the present invention. The slit coater in accordance with the present embodiment includes a table 140 on which a substrate 100 is mounted, a slit nozzle unit 120 applying a coating solution, such as a photosensitive solution, onto the substrate 100, and a driving unit 150 installed at both ends of the slit nozzle unit 120 and configured to move the slit nozzle 120 at a constant speed.

The driving unit 150 includes a pair of Z-axial driving apparatuses 151 installed at both ends of the slit nozzle unit 120 and moving the slit nozzle unit 120 up and down, and a pair of Y-axial driving apparatuses 152 moving the slit nozzle unit 120 back and forth across the table 140 at a constant speed to uniformly apply the photosensitive solution to a surface of the substrate 100. The Z-axis is the vertical direction pointing directly above or perpendicular to the table 140, the X-axis is the direction between the two sets of driving apparatuses 151, 152 and the Y-axis is in the direction of the plane surface of the table 140. The Z-axial driving apparatuses 151 are configured to move the slit nozzle unit 120 up and down above the table 140, whereas the Y-axial driving apparatuses 152 are configured to move the slit nozzle unit 120 across the length of the table 140.

Each Y-axial driving apparatus 152 may include a motor (not shown), and a transfer unit (not shown) such as a transfer rail and a guide rail. A non-contact type linear motor can be used as the motor.

An object 100 to be processed such as a glass substrate is mounted onto the table 140, and a plurality of pins 141 for lifting up the substrate 100 from the table 140 are installed inside the table 140. The pins 140 are supported by a plate 142 placed under the table 140 so as to mount or lift the substrate 100 onto or from the table 140 by the vertical movement of the plate 142.

The slit nozzle unit 120 includes a nozzle 122 located above the substrate 100 and crossing the substrate 100 and has the shape of a slit with a length corresponding to the width of the substrate 100, and a head 121 on which the slit nozzle 122 is mounted.

Although not shown in detail in the drawing, the slit nozzle 122 includes a nozzle body, an inlet and an outlet, wherein the nozzle body has a receiving space for storing a photosensitive solution therein. The inlet is formed at the nozzle body and the outlet is formed at a surface of the nozzle body, which faces the substrate 100. Here, the outlet has a slit shape having a length longer than its width.

Also, the slit nozzle 122 applies the photosensitive solution, while moving from one side toward the other side of the substrate 100 by the Y-axial driving apparatuses 152, thereby uniformly applying the photosensitive solution on the surface of the substrate 100. The photosensitive solution may also be applied to the substrate by sliding the substrate 100 relative to the slit nozzle 122, which remains in a fixed position.

Although not shown in the drawing, a bubble outlet for removing bubbles within the slit nozzle 122 is formed at an upper end of the head 121 of the slit is nozzle unit 120.

In the slit coater having such a construction, coating solution in the vicinity of the outlet (not shown) of the slit nozzle 122 is highly concentrated and in contact with air when the slit coater is on service for a certain period, and not performing the coating process. In some cases, the coating solution in a hardened state remains at the outlet of the slit nozzle 122 and causes a defective application when the next operation is performed. Therefore, the substrates are monitored for defects caused by problems in slit coater operation to determine when maintenance of the slit coater is needed.

Accordingly, the slit coater of the present invention further comprises a service unit 160 maintaining a solvent atmosphere. The slit coater having the service unit 160 can prevent the problem of the hardened coating solution by preventing contact between the slit nozzle 122 and air by keeping the slit nozzle 122 in the service unit 160 when the slit nozzle 122 is on service for a long period. In addition, the service unit 160 of the present invention may keep the slit nozzle 122 in a hermetically sealed state. In the application process of the slit nozzle 122, it is closed and sealed by an opening/closing shutter, thereby protecting an operator against harmful solvent steam and simultaneously preventing environmental pollution. With reference to the drawings, this will be described in detail. Here, as one embodiment of the invention shown in the drawings, the service unit 160 is installed at the front of the table 140. But the present invention is not limited to this, and the service unit 160 may be installed at a different point on the table 140 including at the rear of the table 140.

FIG. 4 is a cross-sectional view schematically illustrating a service unit 160 in accordance with a first embodiment of the present invention, the cross-sectional view of the side of the service unit 160 which is illustrated in FIG. 3.

The service unit 160 of the first embodiment includes a cleaning chamber 190 filled with a cleaning solution, a rotating roller 165 horizontally disposed with respect to the cleaning chamber 190, and having a lower portion thereof immersed in cleaning solution inside the cleaning chamber 190 and an upper portion thereof exposed to approach an outlet 126 of the slit nozzle 122, and cleaning solution spray nozzles 170A to 170C for spraying cleaning solution toward a surface of the rotating roller 165.

Both ends of the cylindrical rotating roller 165 are rotatably installed at both side walls facing each other with respect to the perpendicular direction from the surface of the cleaning chamber 190. Though not illustrated in the drawing, a pulley may be mounted at one end of a shaft of the rotating roller 165, and the pulley and the rotating shaft of a motor are coupled with each other by a belt. Thus, the driving force of the motor is transmitted to the rotating roller 165 through the belt.

The rotating roller 165 may be comprised of a metal such as stainless steel, aluminum, titanium or the like. As described, the cleaning chamber 190 of the service unit 160 is filled with a cleaning solution such as high volatile organic solvent, and the lower portion of the rotating roller 165 is immersed therein.

In addition, the first and second spray nozzles 170A and 170B for spraying cleaning solution toward the surface of the rotating roller 165 are installed at the both side walls of the service unit 160. The third cleaning solution spray nozzle 170C is installed in the cleaning chamber 190 under the rotating roller 165.

A cover for an upper surface of the service unit 160 excluding an exhaust port (not shown) is installed at an upper end of the side walls at which the first and second cleaning solution spray nozzles 170A and 170B are installed to thereby maintain the interior of the service unit 160 in a solvent atmosphere. Gas including the cleaning solution laid in the cleaning chamber 190 is exhausted through a duct (not shown) connected to the exhaust port.

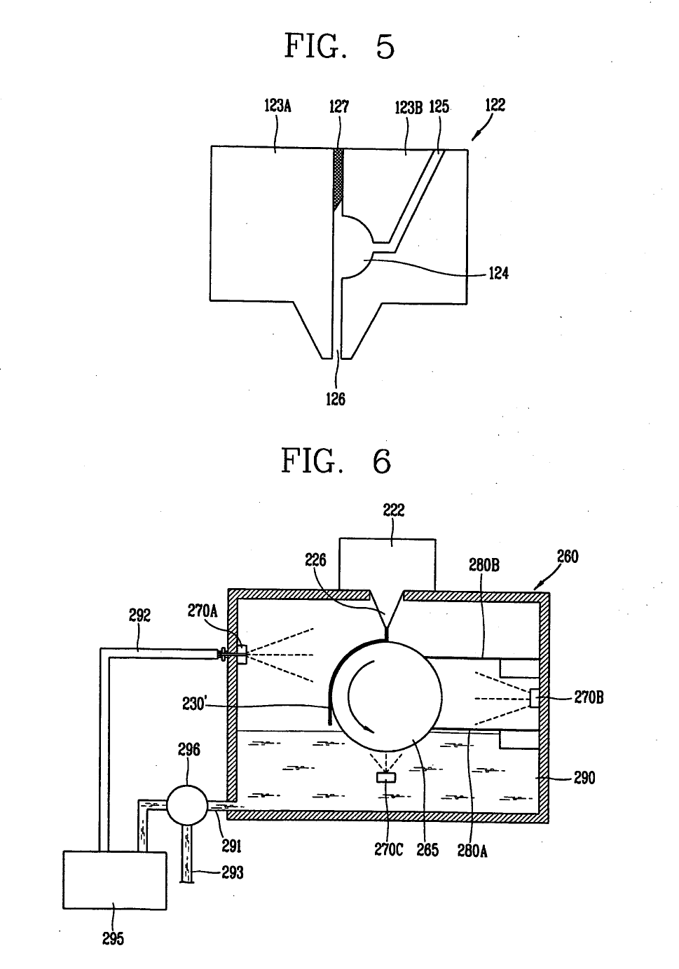

With reference to FIG. 5, the slit nozzle 122 to be kept in the service unit 160 includes a fist nozzle body 123A, a second nozzle body 123B, an inlet 125 and an outlet 126.

The slit nozzle 122 has a structure in which two nozzle bodies 123A and 123B are coupled, and a receiving space 124 for temporarily storing a certain amount of photosensitive solution is formed between the first nozzle body 123A and the second nozzle body 123B in order to uniformly spray the photosensitive solution pressurized by a pumping unit.

The inlet 125 is formed at an upper portion of the second nozzle body 123B and supplies the photosensitive solution to the receiving space 124, and the outlet 126 has a slit shape having a length longer than its width and is formed at a lower portion of the nozzle bodies 123A and 123B facing the substrate, thereby applying the photosensitive solution to the surface of the substrate 100 in a plane form.

A gap between the first nozzle body 123A and the second nozzle body 123B is created and maintained by a very thin shim 127, preferably made of stainless steel.

As described, the service unit 160 of the present embodiment prevents hardening of photosensitive solution at the outlet 126 of the slit nozzle 122 by the solvent atmosphere inside the service unit 160.

Referring back to FIG. 4, the service unit 160 is configured to preferably create a solvent atmosphere therein with the cleaning solution spray nozzles 170A to 170C and the cleaning solution of the internal lower portion, and by the slit nozzle 122 being kept in the service unit 160 having the solvent atmosphere. A photosensitive solution inside the slit nozzle 122 is not evaporated by the solvent atmosphere and the hardening of the photosensitive solution at the outlet 126 of the slit nozzle 122 is prevented.

However, even though the service unit 160 has the solvent atmosphere therein, hardening of the photosensitive solution may occur at the outlet 126 of the slit nozzle 122. If the slit nozzle 122 is left on service over a set period of time, such as one hour, the hardening proceeds and thus discharge may not be properly made in an actual coating process.

According to another embodiment, the slit nozzle 122 is allowed to discharge dummy photosensitive solution periodically, and the aforementioned hardening of the photosensitive solution at the outlet 126 of the slit nozzle 122 is prevented.

The outlet 126 of the slit nozzle 122 comes in close contact to the surface of the rotating roller 165 and periodically discharges dummy photosensitive solution 130′, thereby preventing the hardening of the photosensitive solution at the outlet 126 of the slit nozzle 122.

Since the service unit 160 in the present embodiment has the rotating roller 165 and the cleaning solution spray nozzles 170A to 170C, the discharged dummy photosensitive solution 130′ is pulled down according to rotation of the rotating roller 165 and is attached to the surface of the rotating roller 165. The dummy photosensitive solution 130′ is cleaned and removed by the cleaning solution of the cleaning solution spray nozzle 170A to 170C and the lower portion of the cleaning chamber 190.

Since during the discharge of the dummy photosensitive solution 130′, a side surface of the outlet 126 of the slit nozzle 122 is contaminated by the dummy photosensitive solution 130′, the dummy photosensitive solution 130′ is discharged by allowing the slit nozzle 122 to approach the rotating roller 165 from the outlet 126 to an extent that surface tension is removed and by forming a certain discharge interval (d).

At this point, the discharge interval (d) from the rotating roller 165 to the outlet 126 may be, for example, about 30 to 500 μm. If the discharge interval (d) becomes too great, a side surface of the outlet 126 of the slit nozzle 122 is contaminated by the surface tension of the dummy photosensitive solution 130′ being discharged.

The first cleaning solution spray nozzle 170A and the second cleaning solution spray nozzle 170B may be installed at the side walls of the service unit 160 by using a screw member (not shown) as a medium. A bubbling nozzle may be used as the third cleaning solution spray nozzle 170C installed at the bottom of the cleaning chamber 190.

As a washing method for the bubbling nozzle, the photosensitive solution 130′ is washed away from the attached to the rotating roller 165 by spouting a certain amount of washing solution as a playing fountain does. The method of washing away the photosensitive solution 130′ is through a bubble-like washing solution including gas.

Accordingly, the hardening of the photosensitive solution at the outlet 126 of the slit nozzle 122 is prevented in the solvent atmosphere inside the service unit 160 in a state where the slit nozzle 122 is sealed and simultaneously is prevented by the discharge of the dummy photosensitive solution 130′ of the slit nozzle 122 which is performed at intervals set by the user. In a preferred embodiment, the slit nozzle 122 would be hermetically sealed.

Coating conditions of the substrate 100 may be kept constant all the time even though the slit nozzle 122 does not perform the coating process for a long period and is on service by preventing the photosensitive solution from hardening at the outlet 126 of the slit nozzle 122 by periodically discharging the dummy photosensitive solution 130′ in the solvent atmosphere.

Hereinafter, a method for discharging the dummy photosensitive solution 130′ to prevent the hardening of the photosensitive solution at the outlet 126 of the slit nozzle 122 will be described.

In order to form the same and optimum discharge conditions of the slit nozzle 122 all the time, the dummy photosensitive solution 130′ is discharged so that an interval between the slit nozzle and the rotating roller 165 is small. The dummy photosensitive solution 130′ discharged to the surface of the rotating roller 165 is diluted by a cleaning solution being sprayed by the first cleaning solution spray nozzle 170A on the left in the drawing.

The cleaning chamber 190 at which a certain amount of cleaning solution stays is located at the bottom of the service unit 160, such that the dummy photosensitive solution 130′ can be easily melted by immersing part of the rotating roller 165.

The third cleaning solution spray nozzle 170C on the lower portion of the cleaning chamber 190 serves to dilute and remove the dummy photosensitive solution 130′ which may be smeared on the surface of the rotating roller 165. The second cleaning solution spray nozzle 170B on an upper portion on the right in the drawing removes the final dummy photosensitive solution 130′.

A first coating solution removing unit 180A is installed between the third cleaning solution spray nozzle 170C and the second cleaning solution spray nozzle 170B, and a second coating solution removing unit 180B is installed at an upper portion of the second cleaning solution spray nozzle 170B.

The dummy photosensitive solution 130′ discharged from the slit nozzle 122 is diluted by the first and third cleaning solution spray nozzles 170A and 170C, and the dummy photosensitive solution 130′ smeared on the rotating roller 165 is removed by the first coating solution removing unit 180A. The rotating roller 165 performs the final cleaning by the second cleaning solution spray nozzle 170B. The dummy photosensitive solution 130′ and the cleaning solution smeared on the rotating roller 165 are finally removed by the second coating solution removing unit 180B of the upper portion on the right.

Accordingly, a slit coater having the service unit 160 in accordance with a first embodiment may prevent the hardening of the photosensitive solution at the outlet of the slit nozzle when the slit coater is on service for a long period by allowing the slit nozzle to have a solvent atmosphere therein and keeping the slit nozzle therein and allowing the slit nozzle to periodically discharge dummy photosensitive solution.

FIG. 6 is a cross-sectional view illustrating a service unit in accordance with a second embodiment of the present invention.

Here, the service unit of the present embodiment includes the same components as the service unit of the first embodiment except for the addition of a return tank for reusing cleaning solution.

As illustrated therein, a service unit 260 of a second embodiment includes a cleaning chamber 290 filled with cleaning solution, a rotating roller 265 horizontally disposed with respect to the cleaning chamber 290, and having a lower portion immersed in the cleaning solution inside the cleaning chamber 290 and an upper portion exposed to approach an outlet 226 of the slit nozzle 222, and cleaning solution spray nozzles 270A to 270C for spraying cleaning solution toward a surface of the rotating roller 265.

As for the rotating roller 265, both ends of the cylindrical rotating roller 265 are rotatably installed at both side walls facing each other in a perpendicular direction with respect to the surface of the cleaning chamber 290. The cleaning chamber 290 of the service unit 260 is filled with cleaning solution such as high volatile organic solvent, and the lower portion of the rotating roller 265 is immersed therein.

In addition, the first and second spray nozzles 270A and 270B for spraying cleaning solution toward the surface of the rotating roller 265 are installed at both side walls of the service unit 260. The third cleaning solution spray nozzle 270C is installed in the cleaning chamber 290 under the rotating roller 265. FIG. 6 shows a dummy photosensitive solution 230′ configured to function similar to the dummy photosensitive solution 130′ as in the embodiment shown in FIG. 4. Likewise, FIG. 6 also shows a first and second coating solution removing unit 280A, 280B, also configured to function similar to the first and second coating solution removing unit 180A, 180B as in the embodiment shown in FIG. 4.

Still referencing FIG. 6, a cover for an upper surface of the service unit 260 excluding an exhaust port (not shown) is installed at an upper end of the side walls at which the first and second cleaning solution spray nozzles 270A and 270B are installed to thereby prevent evaporation of cleaning solution as much as possible such that the interior of the service unit 260 maintains a solvent atmosphere. Here, gas including the cleaning solution laid in the cleaning chamber 290 is exhausted through a duct (not shown) connected to the exhaust port.

A return pipe 291 for returning and reusing cleaning solution is installed at a side wall near the bottom of the cleaning chamber 290. A pump 296 and a filter (not shown) are coupled with the return pipe 291 to thereby return the cleaning solution inside the cleaning chamber 290 to a return tank 295.

The cleaning solution returned to the return tank 295 is sprayed through the cleaning solution spray nozzle 270A via a supply pipe 292 and is therefore configured to be reused.

In the present embodiment, the returned cleaning solution is supplied to the first cleaning solution spray nozzle 270A via the supply pipe 292 as an example, but the present invention is not limited to this. The returned cleaning solution may be supplied instead to the second cleaning solution spray nozzle 270B or the third cleaning solution spray nozzle 270C via the supply pipe 292 and can then be reused. The supply pipe 292 may supply cleaning solution to only one of the cleaning solution spray nozzles 270A to 270C or it may supply cleaning solution to a plurality of the cleaning solution spray nozzles 270A to 270C.

Here, though not illustrated in the drawing, a sensor may be installed at a side wall of the service unit 260 and cleaning solution continues to be stored until a pre-set upper limit level of the return tank 295 is checked. When the upper limit is sensed according to the sensor, if return to the return tank 295 is possible, the cleaning solution is returned to the return tank 295, and if the return to the return tank 295 is impossible, the cleaning solution is discarded through a waste liquid pipe 293 to a waste liquid tank (not shown).

Accordingly, the service unit of the second embodiment can prevent waste of cleaning solution by returning and reusing the cleaning solution according to a preset reference amount stored in the return tank.

In a further embodiment, a service unit for pre-applying a coating solution may be installed at one side of the table. The service unit is used when a coating process is first started or when the coating of another substrate is prepared after the coating process is completed. In a preferred embodiment, the service unit for pre-applying a coating solution is a separate component from the service unit 160 and 260 described above. The service unit for pre-applying coating solution is positioned at a different side of the table from the service unit 160 and 260 described above. In an alternative configuration, the functions of the standby operation described above and the pre-applying operation described below, can be carried out in the same component.

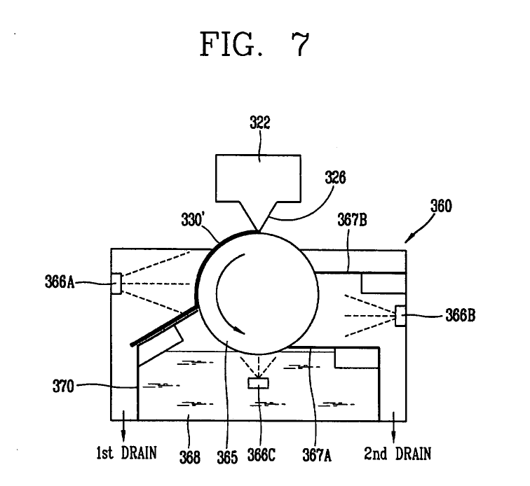

FIG. 7 is a schematic sectional view of a service unit in accordance with another embodiment of the present invention, in which a coating solution is pre-applied to a roller. The service unit functions to improve the coating uniformity when a slit nozzle applies coating solution to a substrate, such as a substrate for an LCD device.

As shown, the service unit 360 in accordance with the present embodiment includes a washing container 368 filled with a washing solution, a rotating roller 365 disposed horizontally with respect to the washing container 368, wherein a lower portion of the rotating roller 365 is immersed in the washing solution within the washing container 368. The upper portion of roller 365 is exposed to provide an approach for the slit nozzle 322. Washing solution spray nozzles 366A to 366C are positioned in washing container 368 to spray the washing solution toward the surface of the rotating roller 365.

Both ends of the cylindrical rotating roller 365 are rotatably installed at the side walls that face each other and are formed vertically on a bottom of the washing container 368. Although not shown in the drawing, a pulley is mounted at one end of a shaft of the rotating roller 365, and the pulley and a rotating shaft of a motor are coupled together by a belt, so that a driving force of the motor is transferred to the rotating roller 365 through the belt.

The rotating roller 365 may be formed of a metal such as stainless steel, aluminum, titanium, or the like.

A washing solution such as a highly-volatile organic solvent is filled in the washing container 368 of the service unit 360, and the lower portion of the rotating roller 365 is immersed in the washing solution.

Also, first and second washing solution spray nozzles 366A and 366B for spraying the washing solution toward the surface of the rotating roller 365 are installed at both side walls of the service unit 360. A third washing solution spray nozzle 366C is installed within the washing container 368 under the rotating roller 365.

Before or after the application process, the service unit 360 of the present embodiment can prevent the aforementioned defective application, such as non-uniform coating. In one method, the outlet 326 of the slit nozzle 322 approaches a surface of the rotating roller 365, applies the highly-concentrated photosensitive solution 330′ to the service unit 360, and thusly allows the photosensitive solution with certain concentration to remain in the slit nozzle 322.

In order to always maintain the best applying condition, before or after the photosensitive solution is applied onto the glass substrate, the highly-concentrated photosensitive solution 330′ is applied through the outlet 326 of the slit nozzle 322 in a state that a uniform interval between the outlet 326 and the rotating roller 365 is maintained.

In the illustrated embodiment, the photosensitive solution 330′ applied onto the surface of the rotating roller 365 is diluted by washing solution sprayed from the first washing solution spray nozzle 366A, and then is discharged to a photosensitive solution drain (1^{st} drain) through a photosensitive solution separating unit 370 formed at a lower end of the left side of the washing container 368. One end portion of the separating unit 370 is adjacent to the surface of the rotating roller 365 so as to separate the spread photosensitive solution 330′ from the washing solution and discharge the photosensitive solution 330′.

Although the case where the photosensitive solution separating unit 370 is installed at the lower end of the left side of the washing container 368 is taken as an example in the drawing, the present invention is not limited thereby, and its installation position is determined by a direction in which the rotating roller 365 rotates. Specifically, if the rotating roller 365 rotates counterclockwise, the photosensitive solution separating unit 370 is installed at the left side as shown in FIG. 7 and, if the rotating roller 365 rotates clockwise, the photosensitive solution separating unit 370 may be installed at the right side. Also, the photosensitive solution separating unit 370 may be installed at an upper side or a lower side to separate the photosensitive solution 330′ from the washing solution.

Because a certain amount of washing solution always stays in the washing container 368 of the service unit 360, a part of the rotating roller 365 is immersed in the washing solution, so that some photosensitive solution 330′ which has not been removed by the photosensitive solution separating unit 370 can be washed.

The third washing solution spray nozzle 366C installed at a lower portion of the washing container 368 and the second washing solution spray nozzle 366B installed at a right side of the service unit 360 are for diluting and removing some remaining photosensitive solution 330′. A first photosensitive solution removing unit 367A and a second photosensitive solution removing unit 367B installed under and above the second washing solution spray nozzle 366B, respectively, are for removing the remaining photosensitive solution 330′ and the lastly-sprayed washing solution.

Although the case where the first photosensitive solution removing unit 367A is installed at the right side wall of the washing container 368 is taken as an example in the drawing, the present invention is not limited thereby and the first photosensitive solution removing unit 367A may be installed at the right side wall of the service unit 360 like the second photosensitive solution removing unit 367B. A drain (2^{nd} drain) for discharging extra washing solution within the washing container 368 is installed between a side wall of the service unit 360 and the washing container 368 where the first photosensitive solution removing unit 367A is installed.

The first washing solution spray nozzle 366A and the second washing solution spray nozzle 366B may be installed at the side wall of the service unit 360 by using a screw member (not shown) as a medium, and a bubbling nozzle may be used as the third washing solution spray nozzle 366C installed at the washing container 368.

In one bubbling nozzle washing method, photosensitive solution 330′ attached to the rotating roller 365 is washed away by spraying a certain amount of washing solution as a playing fountain does and washing away the photosensitive solution 330′ using a bubble-like washing solution including gas.

In the service unit 360 of the present embodiment, one end portion of the photosensitive solution separating unit 370 is adjacent to the rotating roller 365 in the service unit 360 so as to separate the highly-concentrated photosensitive solution 330′ having been spread to the surface of the rotating roller 365 from the washing solution and discharge the separated photosensitive solution 330′. Thus, the highly-concentrated photosensitive solution 330′ is not mixed with the washing solution, thereby preventing the washing solution from being polluted by the photosensitive solution 330′. As a result, washing effect of the rotating roller 365 can be improved when the washing solution is reused, and the number of times the washing solution is reused is increased.

As the present invention may be embodied in several forms without departing from the spirit or essential characteristics thereof, it should also be understood that the above-described embodiments are not limited by any of the details of the foregoing description, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A slit coater comprising:
a table on which an object to be processed is positioned;
a slit nozzle unit configured to apply a coating solution onto a surface of the object; and
a service unit onto which the slit nozzle unit is loaded, and having an inner space maintained in a substantially sealed solvent atmosphere.

2. The slit coater of claim 1, wherein the coating solution comprises one of a photosensitive solution, a development solution, or a color filter.

3. The slit coater of claim 1, wherein the slit nozzle unit comprises a nozzle having a slit and having a length longer than its width and having a head onto which the nozzle is mounted.

4. The slit coater of claim 1, wherein the service unit is installed at a location selected from one of the front or the rear of the table.

5. The slit coater of claim 1, wherein the service unit comprises:
a cleaning chamber filled with cleaning solution;
a rotating roller disposed in the cleaning chamber, the rotating roller on which a dummy coating solution is discharged from the slit nozzle; and
at least one cleaning solution spray nozzle for spraying cleaning solution onto the rotating roller.

6. The slit coater of claim 5, wherein the rotating roller is horizontally disposed with respect to the cleaning chamber, and has a first portion immersed in the cleaning solution and a second portion exposed to approach the slit nozzle.

7. The slit coater of claim 5, wherein the cleaning solution spray nozzle comprises a first cleaning solution spray nozzle and a second cleaning solution spray nozzle, wherein at least one cleaning solution spray nozzle is configured to dilute the dummy coating solution applied onto a surface of the rotating roller when the dummy coating solution is discharged from the slit nozzle.

8. The slit coater of claim 7, wherein the cleaning solution spray nozzle comprises a third cleaning solution spray nozzle installed in the cleaning chamber and configured to dilute the dummy coating solution applied onto the surface of the rotating roller.

9. The slit coater of claim 8, further comprising:
at least one coating solution removing unit installed at a side surface of the service unit and configured to remove the dummy coating solution.

10. The slit coater of claim 1, wherein the service unit maintains a substantially solvent atmosphere therein from the cleaning solution in a cleaning chamber and the cleaning solution being sprayed from at least one cleaning solution spray nozzle.

11. The slit coater of claim 10, wherein the cleaning solution comprises high volatile organic solvent.

12. The slit coater of claim 1, further comprising:
a return pipe installed at a surface of a portion of the service unit and returning the cleaning solution used in the service unit; and
a return tank for storing the cleaning solution returned from the return pipe.

13. The slit coater of claim 12, further comprising:
a supply pipe for supplying the cleaning solution returned from the return tank to the service unit.

14. The slit coater of claim 1, wherein the service unit comprises:
a washing container filled with washing solution;
a rotating roller disposed in the washing container and configured to receive pre-applied coating solution from the slit nozzle;
first, second, and third washing solution spray nozzles each configured to spray washing solution to one side, the opposite side, and a lower surface, respectively, of the rotating roller; and
a coating solution separating unit in the service unit, wherein one end portion of the coating solution separating unit is adjacent to a surface of the rotating roller and configured to separate the coating solution on the surface of the rotating roller from the washing solution and to discharge the separated coating solution.

15. A method for fabricating an LCD device, comprising:
coating an object with a coating solution by using a slit nozzle of a slit coater;
monitoring the object to determine when maintenance of the slit coater is needed;
loading the slit nozzle into a service unit in which a substantially solvent atmosphere is maintained from a cleaning solution; and
removing the slit nozzle from the service unit.

16. method of claim 15, further comprising:
a driving unit for moving one of the slit nozzle unit or a table in a predetermined direction.

17. method of claim 15, further comprising:
discharging dummy coating solution in the service unit from the slit nozzle.

18. The method of claim 15, wherein a substantially solvent atmosphere is formed in the service unit from the cleaning solution in a cleaning chamber and from spraying the cleaning solution from at least one cleaning solution spray nozzle.

19. The method of claim 17, wherein the dummy coating solution discharged from the slit nozzle is discharged to a surface of a rotating roller disposed in the service unit of the nozzle.

20. The method of claim 19, wherein the dummy coating solution discharged from the slit nozzle is periodically discharged to the rotating roller.

21. The method of claim 19, further comprising diluting the dummy coating solution discharged to the surface of the rotating roller by spraying cleaning solution on the surface of the rotating roller.

22. The method of claim 21, further comprising physically removing the diluted dummy coating solution from the surface of the rotating roller.

23. The method of claim 15, further comprising returning the cleaning solution of the service unit to a return tank via a return pipe; and
supplying the returned cleaning solution to the service unit via a supply pipe.

24. The method of claim 15, further comprising discarding the cleaning solution of the service unit into a waste liquid tank via a waste liquid pipe.

25. The method of claim 15, wherein coating an object with a coating solution comprises coating an LCD substrate.

26. A method for fabricating an LCD device, comprising:
moving a slit nozzle to a service unit, wherein the service unit has an inner space maintained in a substantially sealed solvent atmosphere;
moving the slit nozzle to an LCD substrate; and
coating the LCD substrate with the coating solution using the slit nozzle.

27. The method of claim 26, further comprising pre-applying a coating solution in the service unit from the slit nozzle.

28. The method of claim 26, wherein moving the slit nozzle to the service unit further comprises:
loading the slit nozzle into the service unit in which a cleaning chamber contains cleaning solution;
rotating a roller disposed in the cleaning chamber and discharging coating solution from the slit nozzle; and
spraying cleaning solution from at least one cleaning solution spray nozzle onto the rotating roller.

29. The method of claim 26, further comprising monitoring the LCD substrate to determine when maintenance of the slit coater is needed; and
loading the slit nozzle into the service unit when a substrate defect is detected.
